(19) United States
(12) Patent Application Publication
(10) Pub. No.: US 2002/0041441 A1
(43) Pub. Date: Apr. 11, 2002

(54) Optical element with microstructures

(75) Inventor: Ying-Fu Wang, Taipei City (TW)

Correspondence Address: Merchant & Gould P.C., P.O. Box 2903, Minneapolis, MN, 55402-0903, US

(73) Assignee: Taiwan Nano Electro-Optical Technology Co., Ltd

(21) Appl. No.: 09/911,559

(22) Filed: Jul. 24, 2001

(30) Foreign Application Priority Data
Oct. 5, 2000 (TW) 089217276

(51) Int. Cl. G02B 5/02; G02B 13/20; G02B 5/04; G02B 7/18

(52) U.S. Cl. 359/599; 359/707; 359/831

(57) ABSTRACT

An optical element includes an optical body having a surface formed with a microstructure set which includes at least two microstructure relieves. At least one of the microstructure relieves has a configuration different from another one of the microstructure relieves. At least one of the microstructure relieves is defined by 3 to 5 faces.

### BACKGROUND OF THE INVENTION

1. Field of the Invention

The present invention relates to an optical element with microstructures which enable the optical element to exhibit excellent optical effects to suit different optical requirements.

2. Description of the Related Art

Optical elements are commonly used in the art to exhibit a desired optical effect. Examples of the known optical elements include a light transmitting plate in an LCD backlighting module, a frontlighting plate in a PDA display panel, and a screen for a projector TV. The optical elements are typically formed with microstructures to perform the desired functions, such as guiding a light beam or altering the path of a light beam. FIG. 1 illustrates a conventional optical element 30 which is used as a screen for a projector TV. The optical element 30 has two opposite sides, each formed with a plurality of parallel strips 31 with convex faces. FIG. 2 illustrates a light transmitting plate 40 in an LCD backlighting module. The light transmitting plate 40 includes a wedge-shaped polymethyl methacrylate plate formed with a plurality of parallel grooves 41 that have V-shaped cross-sections. FIG. 3 illustrates a light transmitting body 60 which is formed with a plurality of parallel microstructure grooves 61 with concave faces. During manufacture, microstructure relieves are formed on a substrate, such as copper, aluminum or plastic substrates, by known diamond cutting techniques. The shape of the resulting microstructure relieves is the inverse of the profile of the cutting blade 51, 53, as illustrated in FIGS. 4 and 5. The substrate 50, 52 may then be directly used as a mold for producing the required optical element via injection molding, hot press molding or cast molding techniques. Alternatively, the substrate 50, 52 may be used for reproducing a stamper via the known techniques, such as electrocasting.

Typically, the microstructure relieves formed on the conventional optical elements are each defined by a curved face, such as the projecting strips 31 on the optical element 30 shown in FIG. 1 and the grooves 61 in the light transmitting body 60 shown in FIG. 3, or by two faces, such as the V-shaped grooves 41 formed in the light transmitting plate 40 shown in FIG. 2. Moreover, a conventional optical element is typically formed with microstructure relieves which are identical in shape. The resulting optical properties and the optical effects thus achieved cannot be controlled as desired to suit various optical requirements.

### SUMMARY OF THE INVENTION

Therefore, the main object of the present invention is to provide to an optical element with microstructures which enable the optical element to exhibit excellent optical effects to suit different optical requirements.

Accordingly, an optical element of the present invention includes an optical body having at least a surface formed with a microstructure set which includes at least two microstructure relieves. At least one of the microstructure relieves has a configuration different from another one of the microstructure relieves. At least one of the microstructure relieves is defined by 3 to 5 faces.

### BRIEF DESCRIPTION OF THE DRAWINGS

Other features and advantages of the present invention will become apparent in the following detailed description of the preferred embodiments with reference to the accompanying drawings, of which:

FIG. 1 is an enlarged fragmentary perspective view illustrating a conventional optical element that is used as a screen for a projector TV;

FIG. 2 is an enlarged fragmentary perspective view illustrating a conventional light transmitting plate;

FIG. 3 is an enlarged fragmentary perspective view illustrating a conventional light transmitting body;

FIG. 4 is a schematic view illustrating formation of V-shaped microstructure grooves using the known diamond cutting technique;

FIG. 5 is a schematic view illustrating formation of curved microstructure grooves using the known diamond cutting technique;

FIG. 6 is a fragmentary sectional view illustrating a microstructure relief formed on a substrate for forming a preferred embodiment of an optical element according to the present invention;

FIG. 7 is a fragmentary sectional view illustrating another microstructure relief formed on the substrate for forming the first preferred embodiment;

FIG. 8 is a fragmentary sectional view illustrating the substrate for forming the first preferred embodiment;

FIG. 9 is a perspective view of the first preferred embodiment;

FIG. 10 is a fragmentary sectional view illustrating a substrate for forming a second preferred embodiment of the optical element according to the present invention;

FIG. 11 illustrates reflection of light rays incident upon an optical element according to the second preferred embodiment of the present invention;

FIG. 12 is a fragmentary sectional view of a third preferred embodiment of the optical element according to the present invention;

FIGS. 13A and 13B illustrate other preferred embodiments of the present invention where the microstructure relieves formed thereon are parallel structures; and

FIG. 14 illustrates another preferred embodiment of the present invention where the microstructure relieves are concentric structures.

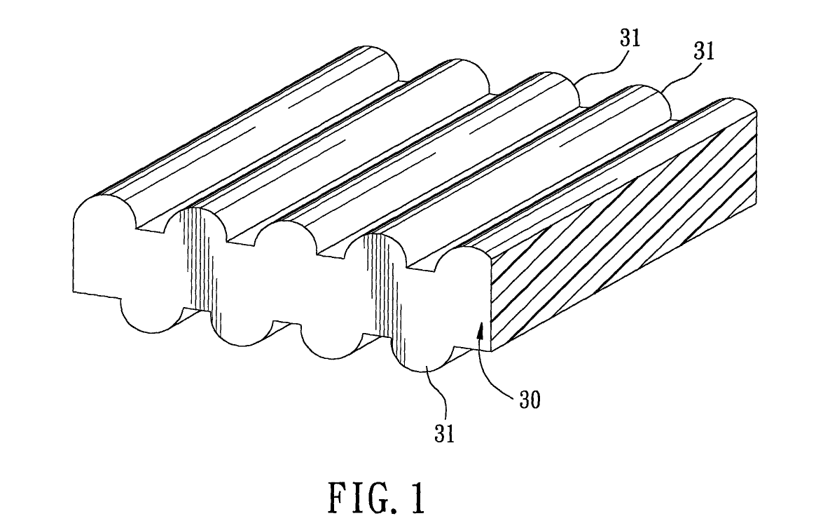

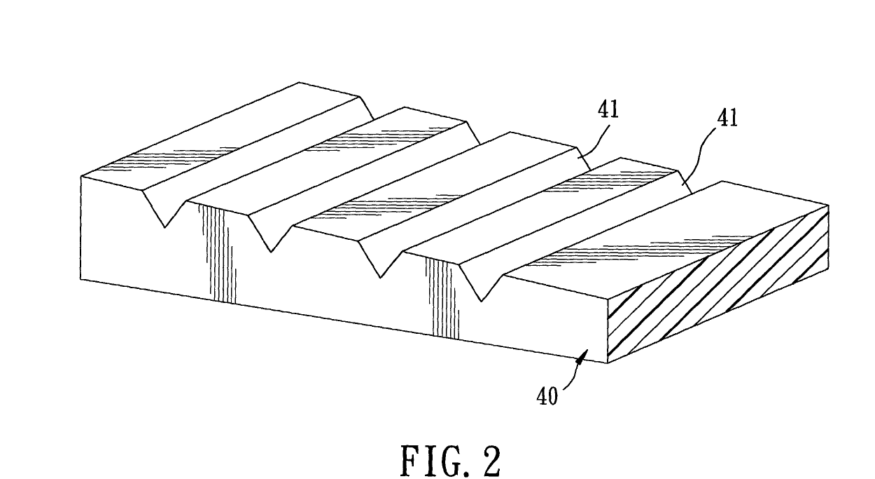

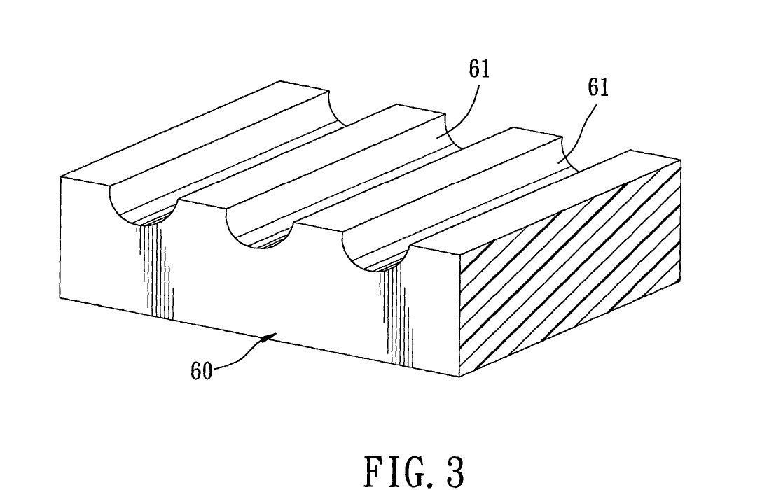

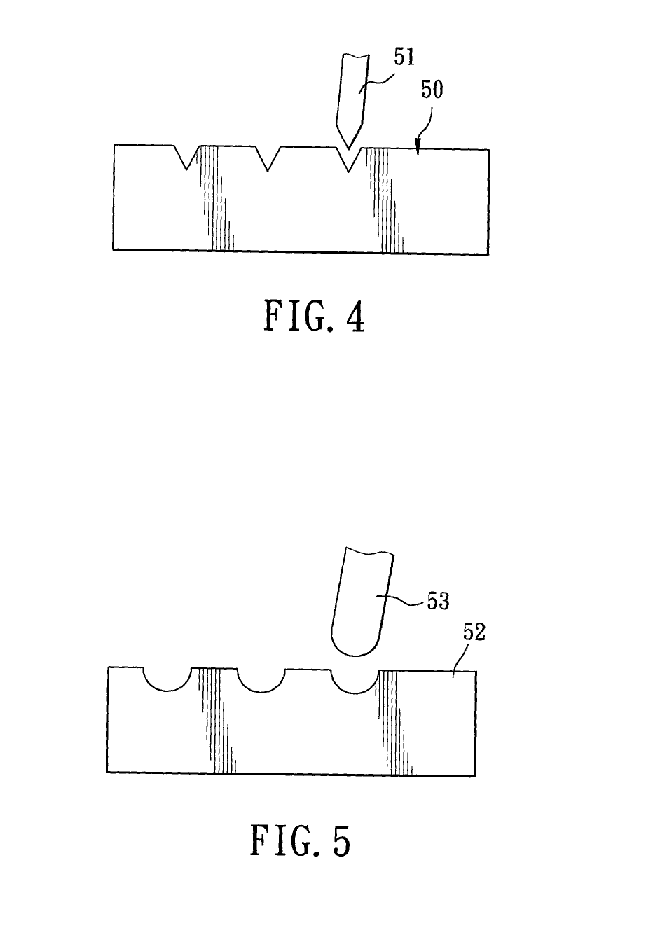

### DETAILED DESCRIPTION OF THE PREFERRED EMBODIMENTS

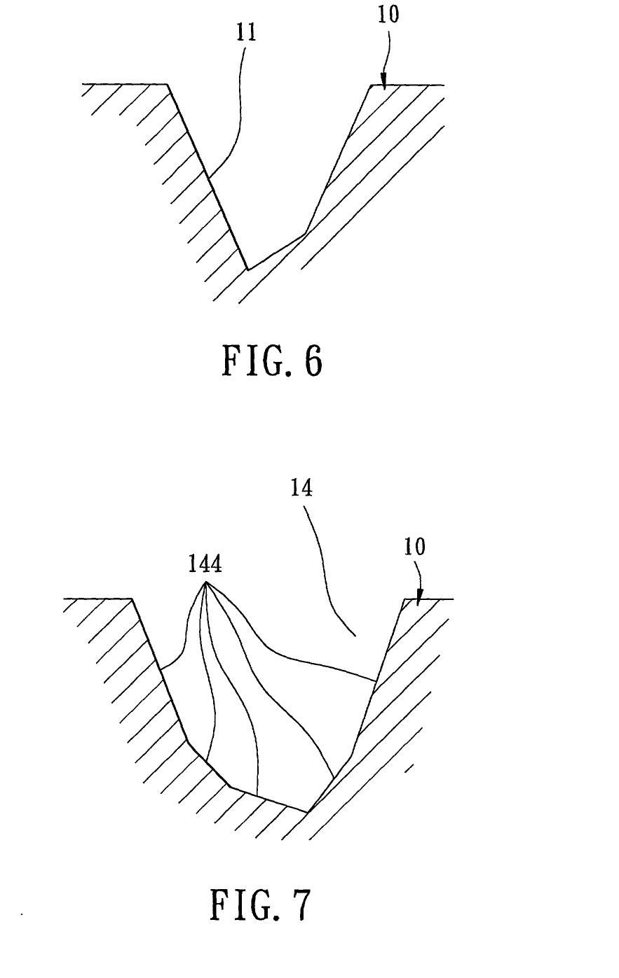

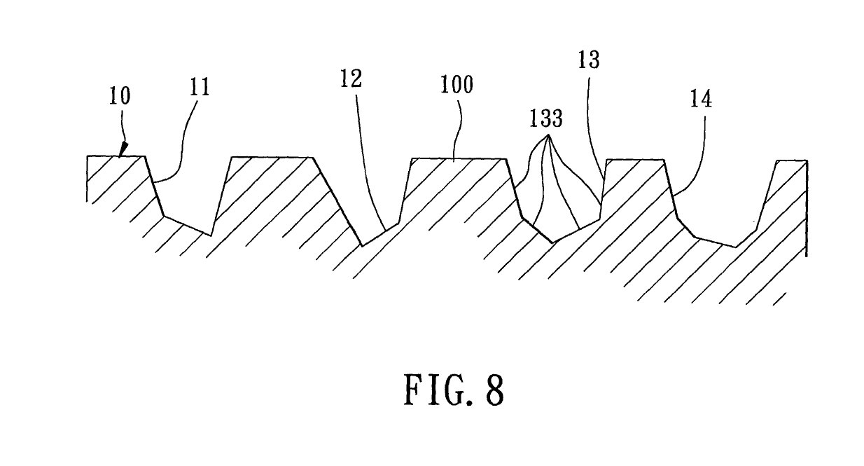

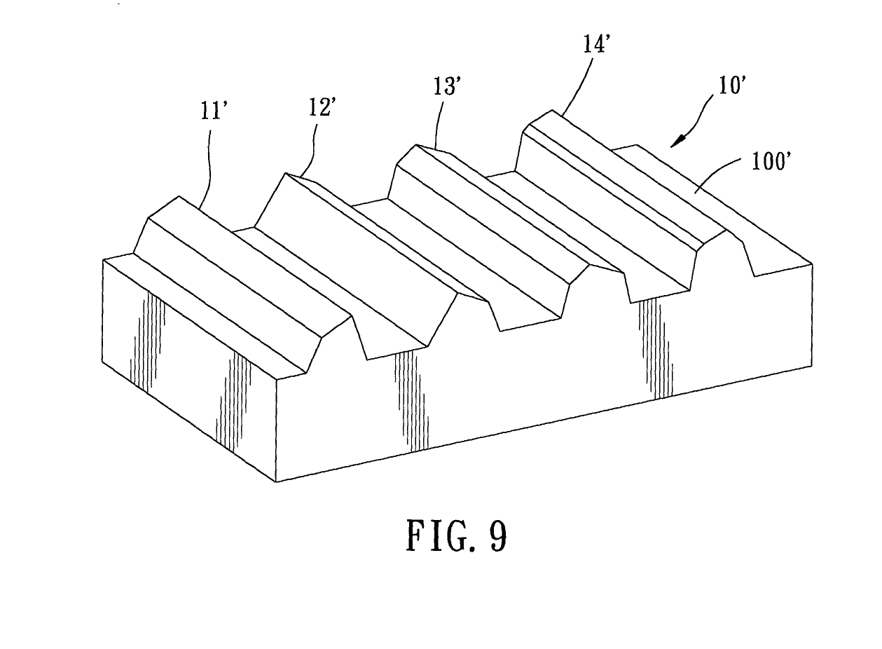

Referring to FIGS. 8 and 9, during the manufacture of an optical element 10′ of the present invention, a primary microstructure set, which includes four primary microstructure relieves 11, 12, 13, 14, is formed on a surface 100 of a first metal substrate 10, such as a copper substrate, via diamond cutting techniques. As shown, the primary microstructure relieves 11, 12, 13, 14 are recessed relative to the surface 100. As shown in FIGS. 6 and 8, two of the primary microstructure relieves 11, 12 are each defined by three faces, and have configurations different from each other. A third one of the primary microstructure relieves 13 is defined by four faces 133. As shown in FIGS. 7 and 8, a fourth one of the primary microstructure relieves 14 is defined by five faces 144. In case one of the primary microstructure relieves is defined by more than five faces, the manufacturing process will be undesirably complicated, and the manufacturing cost will be raised significantly. Preferably, the primary microstructure relieves are each defined by three to five faces, and at least one of the primary microstructure relieves has a configuration different from another one of the primary microstructure relieves. The metal substrate 10 can then be used as a stamper for forming the optical element 10′ shown in FIG. 9. The optical element 10′ thus has an optical body with a surface formed with microstructure relieves 11′, 12′, 13′, 14′ which project from a surface 100′ of the optical body and which have profiles that are the inverse of the primary microstructure relieves 11, 12, 13, 14 on the metal substrate 10. Alternatively, the substrate 10 may be subjected to an inverse casting procedure to form another stamper, which is then used for forming an optical element that has microstructure relieves with profiles corresponding to the primary microstructure relieves 11, 12, 13, 14 on the substrate 10.

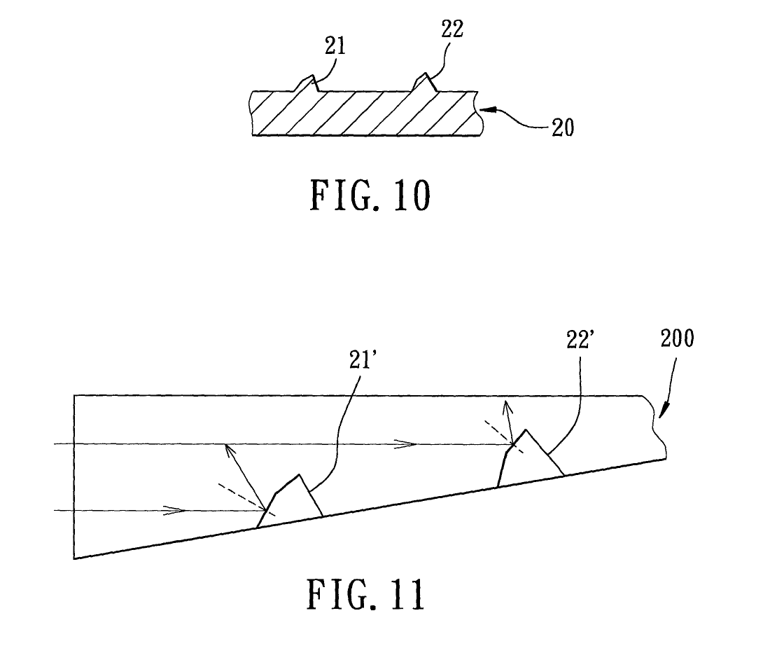

FIG. 10 shows a second metal substrate 20 for forming the second preferred embodiment of an optical element 200 (see FIG. 11) of the present invention. The metal substrate 20 is formed with primary microstructure relieves 21, 22 which project from a surface thereof and which have configurations different from each other. Each of the primary microstructure relieves 21, 22 on the substrate 20 is elongated and is defined by three faces. The metal substrate 20 is formed by inverse casting using another substrate which has microstructure relieves, the profiles of which are the inverse of the primary microstructure relieves 21, 22 on the substrate 20.

FIG. 11 illustrates the optical element 200 formed using the second metal substrate 20 shown in FIG. 10 as a stamper. The optical element 200 includes an optical body having a surface 201 formed with microstructure relieves 21′, 22′ which are recessed relative to a surface of the optical body and which have profiles that are the inverse of the primary microstructure relieves 21, 22 on the metal substrate 20. As shown, when light rays enter the optical element 200, the routes of the light rays turn by different angles when they are incident respectively upon the microstructure relieves 21′, 22′, which have configurations different from each other.

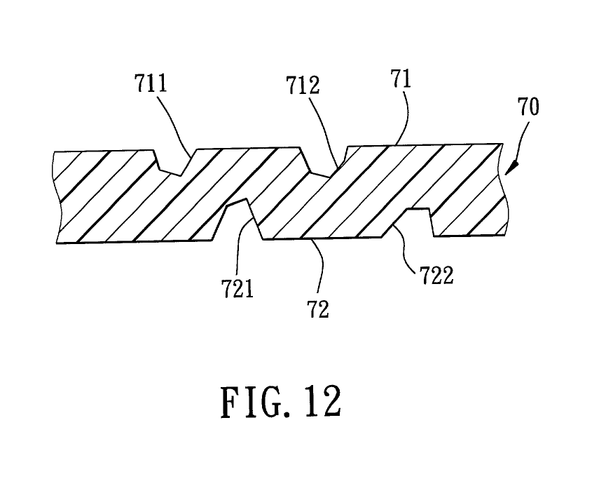

If necessary, the optical element of the present invention may be formed with two sets of microstructure relieves, each set being formed on a respective one of two opposite surfaces of the optical element. Referring to FIG. 12, a third preferred embodiment of the optical element 70 of the present invention is shown to include an optical body formed as a flat plate and having opposite first and second surfaces 71, 72. The first surface 71 is formed with a first microstructure set which includes microstructure relieves 711, 712 that are recessed relative to the first surface 71 and that are defined by three and four faces, respectively. The second surface 72 is formed with a second microstructure set which includes microstructure relieves 721, 722 that are each defined by three faces and that have configurations different from each other. The optical element 70 is formed using two different metal substrates, each being formed with a primary microstructure set which has a profile that is the inverse of a respective one of the first and second microstructure sets on the optical element 70.

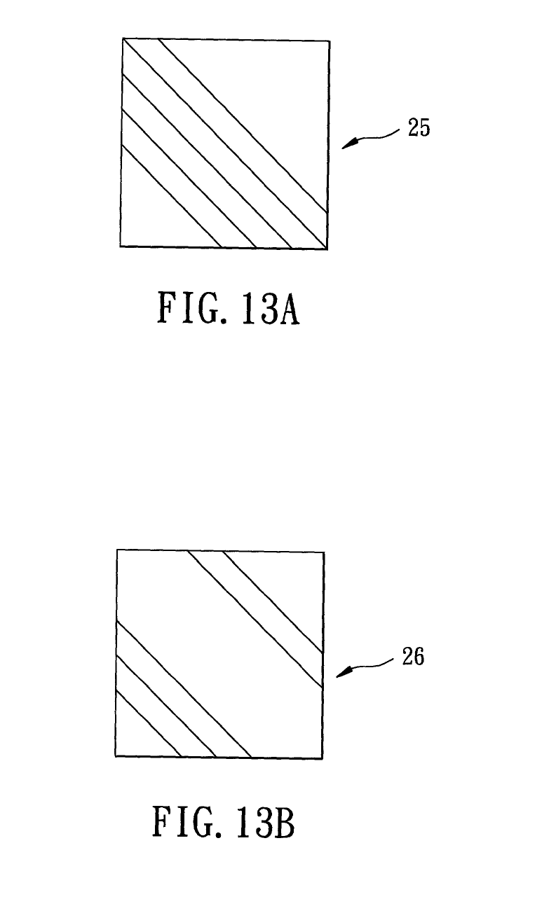

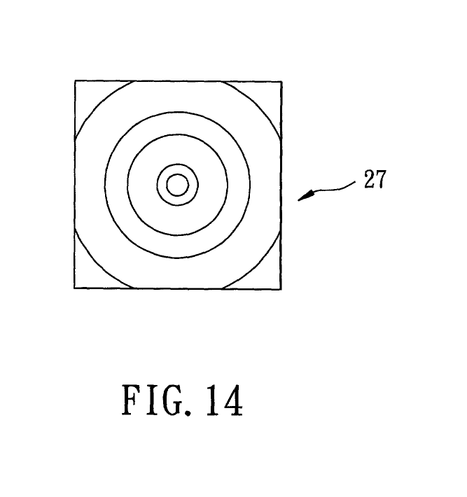

In other embodiments of the optical element of the present invention, the microstructure set may include parallel microstructure relieves which are equally or non-equally displaced from one another, such as the optical elements 25, 26 shown in FIGS. 13A and 13B. Furthermore, the microstructure set may include concentric circular microstructure relieves 11, such as the optical element 27 shown in FIG. 14.

The microstructure relieves may be formed on one or more than one surface of an optical body to form the desired optical element, which may then be used for various optical purposes, such as a light guiding plate, a backlighting plate or a frontlighting plate.

The primary microstructure relieves on the metal substrate may be formed via diamond cutting techniques, and have high form accuracy and high surface smoothness. The resulting microstructure relieves formed on the optical body similarly have high form accuracy and an even mirror surface with a high surface smoothness since the microstructure relieves on the optical body are transferred from the primary microstructure relieves on the substrate.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An optical element comprising:
an optical body having a first surface formed with a first microstructure set which includes at least two microstructure relieves, at least one of said microstructure relieves having a configuration different from another one of said microstructure relieves, at least one of said microstructure relieves being defined by 3 to 5 faces.

2. The optical element as claimed in claim 1, wherein at least one of said microstructure relieves projects from said first surface.

3. The optical element as claimed in claim 1, wherein at least one of said microstructure relieves is recessed relative to said first surface.

4. The optical element as clamed in claim 1, wherein said microstructure relieves are elongated and are parallel to one another.

5. The optical element as claimed in claim 1, wherein said microstructure relieves are circular in shape and are concentrically distributed on said first surface.

6. The optical element as claimed in claim 1, wherein said optical body is formed as a flat plate.

7. The optical element as claimed in claim 6, wherein said optical body further has a second surface opposite to said first surface, said second surface being formed with a second microstructure set which includes at least two microstructure relieves, at least one of said microstructure relieves of said second microstructure set having a configuration different from another one of said microstructure relieves of said second microstructure set, at least one said microstructure relieves of said second microstructure set being defined by 3 to 5 faces.

8. The optical element as claimed in claim 1, wherein said optical element is a backlighting plate.

9. The optical element as claimed in claim 1, wherein said optical element is a frontlighting plate.

10. The optical element as claimed in claim 1, wherein said optical element is a light transmitting plate.
